(19) United States
(12) Patent Application Publication
(10) Pub. No.: US 2021/0136236 A1
(43) Pub. Date: May 6, 2021

(54) GENERATING AN OUTLINE PREVIEW

(71) Applicant: Hewlett-Packard Development Company, L.P., Spring, TX (US)

(72) Inventor: Subhash Pulikkara Veedu, Bangalore (IN)

(21) Appl. No.: 16/478,430

(22) PCT Filed: Nov. 16, 2017
(86) PCT No.: PCT/US2017/061990

§ 371 Date: Jul. 16, 2019

(30) Foreign Application Priority Data
Jan. 25, 2017 (IN) IN 201741002958

(51) Int. Cl. H04N 1/00

(52) U.S. Cl. CPC H04N 1/0044; H04N 1/00748; H04N 1/00729; H04N 1/00702

(57) ABSTRACT

Example for generating an outline preview of a printed medium are described. In one example, presence of a printed medium atop a supporting pane fitted onto an enclosed housing of a scanning system is ascertained using a plurality of sensors arranged in an array beneath the supporting pane. Thereafter, position of the printed medium on the supporting pane based on proximity of the printed medium with each of the plurality of sensors, is estimated- Based on the estimation, the position of the printed medium in relation to a specified scan area setting of a printable format is correlated. The scan area setting may be considered as indicative of size of a target medium on which the printable format is to be printed. An outline preview of the printed medium, with respect to an outline of the target medium based on the correlated position of the printed medium, is generated.

### BACKGROUND

Documents or any printed medium with content may be scanned using a scanning device to provide a digitized file format. The digitized file format may be stored or shared through networked computing devices. The printed medium with the content may be of any size. While scanning any printed medium, a certain page setting may be selected to set a standardized page size for the digitized file format. The selected page size may correspond to the size of a target medium on which the digitized file format may be rendered when eventually printed. In cases where the size of the printed medium is smaller than the selected page size, the resulting digitized file format is such that it provides a digitized representation within a specified area corresponding to the selected page setting.

### BRIEF DESCRIPTION OF THE DRAWINGS

The following detailed description references the drawings, wherein:

FIG. 1 is a diagram of an example system for generating an outline preview of a printed medium;

FIG. 2 is a diagram of another example system for generating an outline preview of a printed medium;

FIG. 3 is block diagram of alp example system for generating an outline preview of a printed medium;

FIG. 4 depicts n example method for generating an outline preview a printed medium;

FIG. 5 depicts another example method for generating an outline preview of printed medium; and

FIG. 6 is a block diagram of an example system implementing a non-transitory computer-readable medium, for generating an outline preview of a printed medium.

### DETAILED DESCRIPTION

Documents or any printed medium with content may be digitized to provide a digitized file format corresponding to the content on the printed medium. The printed medium may be a photograph or a printed document, or any of the like. Digitization of such printed medium may be achieved through scanning devices. Scanning devices may be implemented as dedicated scanners, such as a flatbed scanner, or may be incorporated in multifunction devices. The scanning device may include a transparent supporting pane on which the printed medium may be positioned. Once the printed medium is positioned, the digitized file format is generated by capturing light reflected off the surface of the printed medium. The reflected light may be captured, say by charge coupled devices or other such components. Depending on the intensity of the captured and reflected light, the digitized file format may be generated. The digitized file format may be any file which is storable or processable using either a single or a combination computing devices. The digitized file format when printed, renders a representation of the content of the printed medium onto a target medium.

While scanning, a user may specify a scan area setting which specifies an area of the supporting pane which is to be scanned. This in turn may define a page size for the digitized file format. The area of the supporting pane may depend on the size of the target medium onto which the printed medium may be eventually printed. Even though the selected page size, which in turn is based on the scan area setting, is standardized, the size of the printed medium may not be. In certain cases, where the size of the printed medium is smaller than the selected page size, the resulting digitized file format is such that it depicts a representation of the printed medium within a specified area. On the other hand, if the size of the printed medium is greater than the size corresponding to the selected page size for the target medium, then the digitized file format would represent the printed medium as overextending an area thereby resulting in a cropped or partial image representation of the printed medium. Issues with the digitized file format may also arise if the printed medium is not positioned properly, it may again overlap with the boundary of the digitized file format. In both latter cases, the scanning may have to be performed again. Additionally, the orientation of the printed medium while being scanned may not be proper which again may affect the quality of the digitized file format.

Such issues may be visible once a user has scanned the printed medium. In such cases, the user may have to repeat the scanning process till the desired digitized file format is obtained. This increases the time for obtaining the digitized file format through scanning. The supporting pane provided within the scanning devices may include markings corresponding to the selected page size within which a user may position the printed medium. The markings may aid a user to position the printed medium on a transparent supporting pane such that the printed medium may be digitized properly. However, the markings may not be adequate to properly orient the printed medium so as to get a properly aligned digitized file format. It may also be the case, that the printed medium is positioned in a manner such that it over extends or does not fit within the selected page size. In such cases, the user may have to manually and subjectively align or adjust the printed medium onto the supporting pane in order to ensure that the printed medium is digitized appropriately. This, however, may occur after multiple attempts by the user which in turn entails additional time and reduces the overall benefit of such devices.

Approaches for generating an outline preview of a printed medium are described. Such approaches may be implemented in a system for scanning documents, such as a printed medium. The system for scanning may include a supporting pane on which the printed medium may be positioned. In one example, the system may further include a plurality of proximity sensors placed beneath the supporting pane of the scanning device. The sensors may be arranged in a two dimensional array such that it extends beneath the surface of the supporting pane. The proximity sensors would be hereinafter referred to as sensors, without any limitation to the scope of the subject matter as recited in the claims presented herein.

In operation, a user may position a printed medium onto a supporting pane of the scanning system. The printed medium when placed, activates the sensors beneath the supporting pane. The sensors when activated determine the position of the printed medium. In one example, the sensors may detect the relative distance of the printed medium from each of the sensors. The relative distance of the printed medium from each of the sensors may then be, relied on to determine the position of the printed medium on the supporting pane.

A specific scan area setting of a printable format is obtained. The scan area setting defines an area on the supporting pane which is scanned. The printed medium would be scanned, i.e., digitized, if the printed medium is present within the area specified by the scan area setting. The area specified by the scan setting may also be considered as corresponding to the page size of a target medium on which the printable format may be eventually printed. The scan area which is set based on the scan area setting may be at a specific location on the supporting pane.

Once the scan area setting is determined, the position of the printed medium with respect to the scan area is correlated. Based on the correlation, an outline preview is generated for the printed medium and the target medium. The outline preview of the target medium may be considered as an outline which traces the periphery of the scan area as set by the scan area setting. Returning to the operation of the scanning system, the correlation may involve generating an outline preview of the printed medium relative to the outline preview of the target medium. The outline preview of the printed medium as generated is depicted with respect to the outline of the target medium. The outline preview provides an indication of the relative position of the printed medium with respect to the scan area and also with respect to the target medium if the printed medium were to be scanned or printed.

If the user observes that the positioning of the printed medium is to be adjusted, the same may be carried out appropriately. The adjusted position may then be verified. In one example, the outline preview of the printed medium and the target medium may be generated and displayed in real time prior to the scanning operation. In this manner, a user may adjust the position of the printed medium as appropriate till the desired position is reached, and subsequently may initiate the scanning process. Since the user can visibly ascertain the position of the print medium in real time prior to scanning, multiple scans are avoided. This increases the overall efficiency and utility of systems which are used for scanning any printed medium. The approaches as described also do not incur additional computational load on the resources of the scanning system. The mechanisms for implementing the present approaches include proximity sensors which are neither complex nor costly.

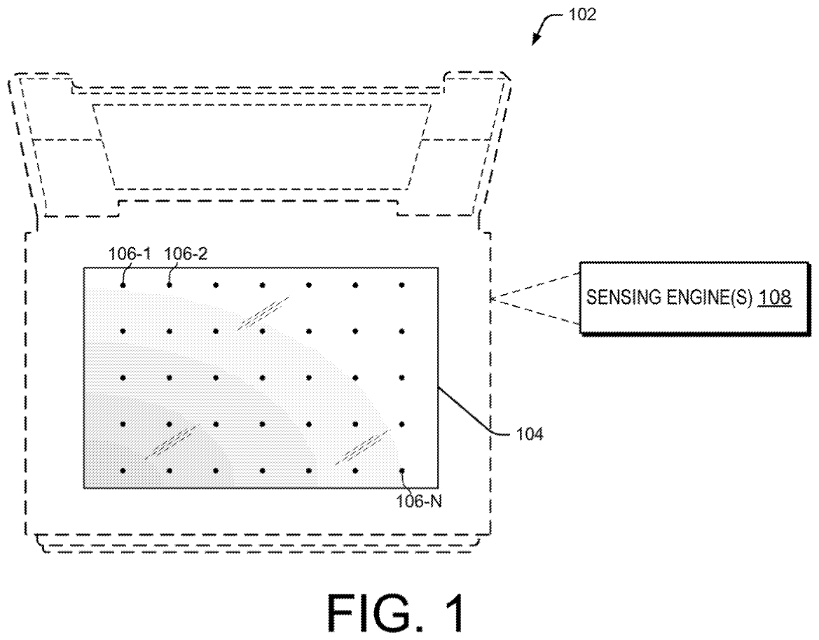

These and other aspects are described in conjunction with various examples as illustrated in FIGS. 1-6. The present description is provided for print devices which may have a print carriage assembly. However, the scope of the present subject matter may not be limited to such print devices. Other print devices may also be included within the scope of the present subject matter without any limitation. Furthermore, in some figures, various components for which no protection is sought have been illustrated using dotted lines.

FIG. 1 illustrates a system 102 for generating an outline preview of a printed medium. The system 102 may be implemented as scanning devices or scanning system for digitizing printed medium to obtain a digitized file format. In the present example, the system 102 includes a transparent supporting pane 104 onto which a printed medium (not shown in FIG. 1) may be positioned while scanning. The system 102 further includes a plurality of sensors 106-1, 2, . . . , N (collectively referred to as sensors 106). The sensors 106 are positioned below the surface of the supporting pane 104. In one example, the sensors 106 may be arranged in a two dimensional array extending beneath the surface of the supporting pane 104. The system 102 further includes sensing engine(s) 108. The sensing engine(s) 108 may, when a printed medium is positioned onto the supporting pane, detect the position of the printed medium based on physical distance of the printed medium from each of the sensors 106. A specific scan area setting of a printable format may be obtained, for example, through user input. Once the scan area setting is obtained, the sensing engine(s) 108 correlates position of the printed medium with respect to a specified scan area setting. Based on the correlation, the sensing engine(s) 108 may further generate an outline preview for the printed medium with respect to and within an outline of the target medium. In an example, the outline preview may be rendered on a display panel (not shown in FIG. 1) in communication with the system 102.

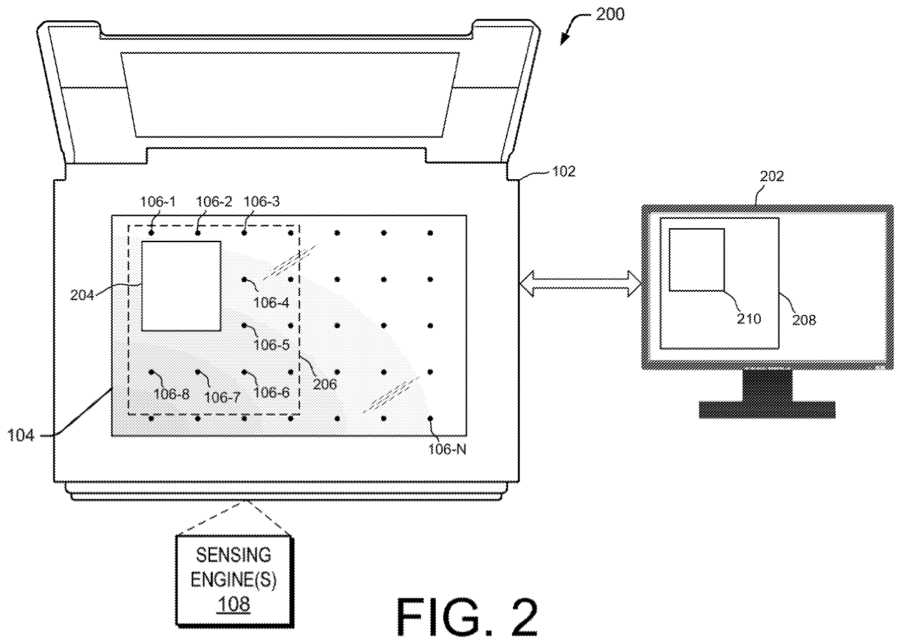

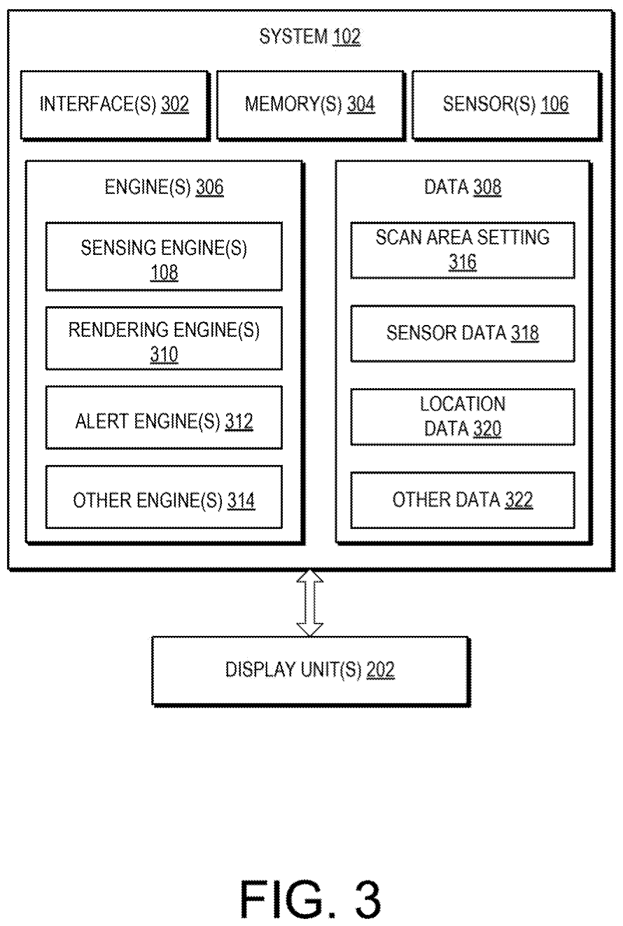

These and other functionalities are provided in further detail in conjunction with FIGS. 2-3. FIG. 2 illustrates an exemplary environment 200 including the system 102 in communication with a display unit 202. The display unit 202 may be implemented as either a standalone device (as depicted) or may be integrated within the system 102, without deviating from the scope of the present subject matter. The system 102 further includes sensors 106-1, 2, N (collectively referred to as sensors 106) positioned beneath the supporting pane 104, and sensing engine(s) 108 for generating an outline preview of a printed medium that may be visually depicted on the display unit 202.

FIG. 3 depicts a block diagram of the system 102. The system 102 includes interface(s) 302, memory(s) 304 and sensors 106. The interface(s) 302 may include a variety of interfaces, for example, interfaces for data input and output devices, referred to as I/O devices, storage devices, network devices, and the like. The interface(s) 302 facilitate communication between the system 102 and other computing devices connected in a networked environment. In one example, the interface(s) 302 may provide an interface for communication between the system 102 and the display unit 202. The memory 304 may store computer-readable instructions, which may be fetched and executed, resulting in generating an alert to enable a user to retrieve a printed document. The memory 304 may include any non-transitory computer-readable medium including, for example, volatile memory such as RAM, or non-volatile memory such as EPROM, flash memory, and the like. The system 102 further includes engine(s) 306 and data 308.

The engine(s) 306 may be implemented as a combination of hardware and programming (for example, programmable instructions) to implement functionalities of the engine(s) 306. In examples described herein, such combinations of hardware and programming may be implemented in a number of different ways. For example, the programming for the engine(s) 306 may be processor executable instructions stored on a non-transitory machine-readable storage medium and the hardware for the engine(s) 306 may include a processing resource (for example, a single processor or a group of processors), to execute such instructions, in the present examples, the machine-readable storage medium may store instructions that, when executed by the processing resource, implement engine(s) 306. In such examples, the system 102 may include the machine-readable storage medium storing the instructions and the processing resource to execute the instructions, or the machine-readable storage medium may be separate but accessible to system 102 and the processing resource. In other examples, engine(s) 306 may be implemented by electronic circuitry.

The data 308 includes data that is either predefined or generated as a result of the functionalities implemented by any of the engine(s) 306. In an example, the engine(s) 306 include the sensing engine(s) 108, a rendering engine(s) 310, alert engine(s) 312 and other engine(s) 314. The other engine(s) 314 may implement functionalities that supplement applications or functions performed by the system 102. Further, the data 308 may include scan, area setting 316, sensor data 318, location data 320 and other data 322.

The process for generating an outline preview of a printed medium may be initiated by a user intending to digitize or generate a digitized file format of a printed medium, such as the printed medium 204. The printed medium 204 may be any media on which content may be provided. The printed medium 204 may be a document having a combination of textual content and images, or may be an image as well. As also explained previously, digitization is performed by scanning the printed medium 204. The digitized file format may be considered as any computer processable and storable file format which carries a digital representation of the content of the printed medium 204.

As the printed medium 204 is positioned on the supporting pane 104, the sensors 106 may get activated. The activation of the sensors 106 may be automated or may be based on a manual input from the user. In one example, the sensors 106 are proximity sensors. The sensors 106 in the present example, are utilized for determining a position of the printed medium 204 on the supporting pane 104. The sensors 106 may be one of capacitive based proximity sensor and a photoelectric based proximity sensor, without limiting the scope of the present subject matter. In one example, the sensors 106 on sensing proximity of the printed medium 204 may generate a plurality of signals. The sensing engine(s) 108 may detect the signals to ascertain that a printed medium, such as the medium 204 is positioned on the supporting Pane 104.

The sensors 106 may be used for determining the location of the printed medium 204. The proximity sensors, such as sensors 106, may sense presence of an object, such as the printed medium 204, in its vicinity. Depending on the distance of the printed medium 204, the sensors 106 may further generate signals. The attributes of the signal may vary depending on the distance of the printed medium 204 from the respective sensors. The attributes may include measure of voltage of the signal, as an example. Referring to FIG. 2, the printed medium 204 is illustrated as being positioned on the supporting pane 104. The printed medium 204 in its position lies directly over some sensors (which are not visible). Few other sensors, such as sensor(s) 106-1, 2, . . . , 8 on the other hand lie some distance away from the edges of the of the printed medium 204. The remaining sensors 106 are even further away from the printed medium 204.

In such a case, signals generated by sensors laying directly beneath the printed medium 204 would differ from the signals otherwise being generated by sensor(s) 106-1, 2, . . . , 8, For example, the voltage of signals generated by sensors laying beneath the printed medium 204 may be greater than the voltage of signals generated by the sensor(s) 106-1, 2, . . . , 8, indicating that the distance between the printed medium 204 of former sensors is less than the distance with the sensor(s) 106-1, 2, . . . , 8. Any other attribute other than voltage may also be relied on without deviating from the scope of the present subject matter. In this manner, other sensors lying further from the printed medium 204 may signals indicative of their relative distance from the printed medium 204. The information pertaining to various attributes may be stored as sensor data 318.

The sensing engine(s) 108 may further obtain the sensor data 318 pertaining to the signals registered by the sensors 106 in response to the presence of the printed medium 204. The sensing engine(s) 108 may further process the sensor data 318 to determine the location of the printed medium 204 on the supporting pane 104. For example, the sensing engine(s) 108 may utilize a mapping which correlates the sensor data 318 with multiple points on the supporting pane 104. Based such a mapping, the sensing engine(s) 108 may estimate the position, i.e., placement of the printed medium 204 on the supporting pane 104.

Once determined, the sensing engine(s) 108 stores the position of the printed medium 204 as location data 320. It may also be the case, that the user may select a scan area setting 316. The scan area setting 316 may be indicative of the size of the target medium onto which the digitized file format of the printed medium 204 may be eventually printed. The scan area setting 316 may be predefined from which the user may select, or may be customizable based on user input. In one example, the scan area setting 316 may store settings based on standardized paper size formats such as A series (i.e., A4, A5, etc.) and B series (i.e., B1, B2, etc.).

When the scan area setting 316 is selected, the sensing engine(s) 108 may define an area 206 (represented by dotted lines in FIG. 2) on the supporting pane 104. The area is so defined, such that the system 102 would scan such a defined area 206 (referred to as scan area 206). The scan area 206 in turn would result in a digitized file format which would conform to the selected paper size based on the scan area setting 316. While printing, a target medium conforming to the selected scan area setting 316 (e.g., paper size) would be selected onto which a physical representation of the digitized file format may be rendered or printed.

Once the scan area setting 316 is determined, the sensing engine(s) 108 may further determine the position and dimensions of the scan area 206 which is to be defined on the supporting pane 104. The rendering engine(s) 310 may further enable rendering an outline 208 for the target medium (shown in FIG. 2) based on the selected scan area setting 316. In one example, the rendering engine(s) 310 may generate control instructions for generating the outline 208 of the target medium (referred to as the target outline 208). The control instruction when processed generate the target outline 208 on the display unit 202. Furthermore, the dimensions of the target outline 208 in turn are based on the scan area setting 316 selected by the user. In one example, the position of the target outline 206 may be with respect to the edges of the supporting pane 104.

Once the target outline 208 is generated, the rendering engine(s) 310 may further generate control instructions which when processed render an outline 210 of the printed medium 204 (referred to as the subject outline 210) on the display unit 202. The control instructions are such that the rendering engine(s) 310 may render the subject outline 210 relative to the target outline 208. As would be observed, the relative position of the target outline 208 with respect to the subject outline 210 is based on the relative position of the printed medium 204 on the supporting pane 104, with respect to scan area 206 defined by the scan area setting 316.

The subject outline 210 and the target outline 208 when rendered onto the display unit 202, give an estimation of the position of the printed medium 204 on the supporting pane 104 to the user. In one example, the target outline 208 and the subject outline 210 may be represented in different visual indicators. The user may accordingly, adjust the position of the printed medium 204 on the supporting pane 104 till it is appropriately positioned. When the position of the printed medium 204 is appropriate, the user may proceed and initiate the scanning process for the printed medium 204.

In one example, the alert engine(s) 312 may further generate visual or audio elements in case the printed medium 204 is not appropriately positioned. For example, it may be possible that the edges of the printed medium 204 are discernably misaligned with respect to the scan area 206, and hence the target outline 208 as well. It may also be the case the printed medium 204 is so positioned such that it extends beyond the scan area 206. In such cases, the subject outline 210 will intersect the target outline 208. The alert engine(s) 312 may determine occurrence of such instances. On occurrence of such instances, it may generate the audio or visual cue to draw the attention of the user. The user may then appropriately adjust the position of the printed medium 204 on the supporting pane 104, In the examples as described, the rendering of the target outline 208 and the subject outline 210 provide a direct and visual indication of the position of the printed medium 204 thereby avoiding the need of repeated scan procedures.

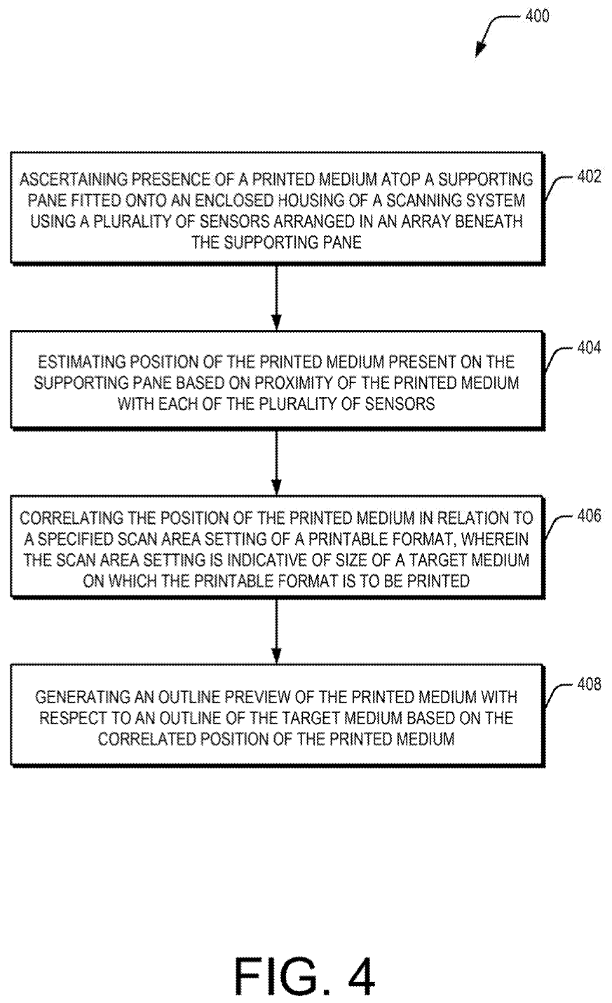

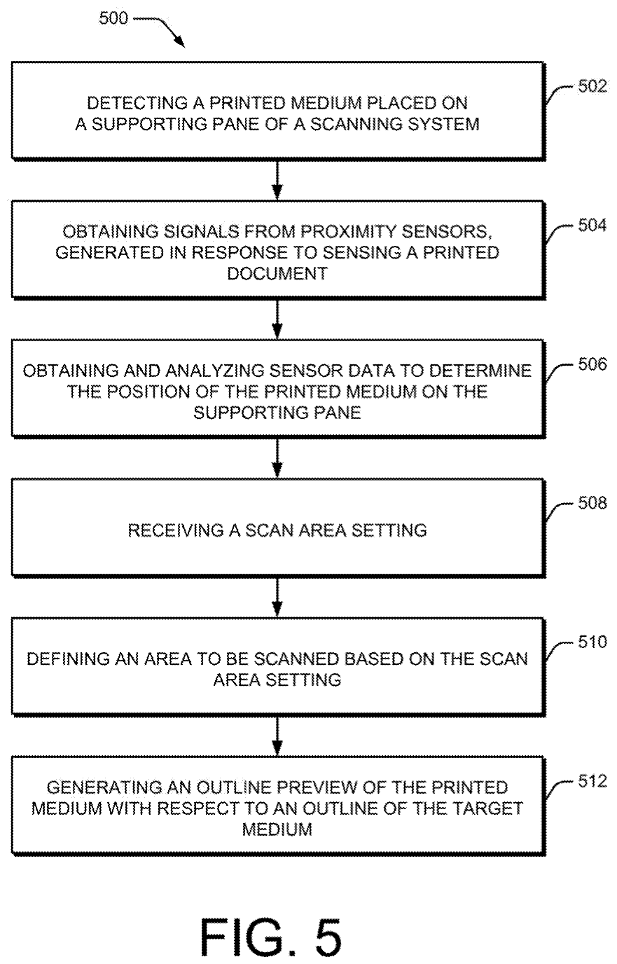

FIGS. 4-5 illustrate example methods 400 and 500, respectively, for metering storage usage within a given storage volume, according to an implementation of the present subject matter. The order in which the methods are described is not intended to be construed as a limitation, and any number of the described method blocks may be combined in any order to implement the aforementioned methods, or another method. Furthermore, methods 400 and 500 may be implemented by processing resource or computing device(s) through any suitable hardware, non-transitory machine readable instructions, or combination thereof.

Returning to FIG. 4, at block 402, presence of a printed medium atop a supporting pane fitted onto a scanning system is ascertained. The presence of the printed medium may be ascertained using a plurality of sensors arranged in an array beneath the supporting pane of the scanning device. For example, the sensors 106 on sensing proximity of the printed medium 204 may generate multiple signals. The sensing engine(s) 108 may detect the signals to ascertain that a printed medium, such as the medium 204 is positioned on the supporting pane 104.

At block 404, position of the printed medium present on the supporting pane is estimated based on proximity of the printed medium with each of the plurality of sensors. For example, the sensing engine(s) 108 may determine the position of printed medium 204 on the supporting pane 104 based on signals generated by sensors 106.

At block 406, the position of the printed medium in relation to a specified scan area setting of a printable format is correlated. The scan area setting is indicative of size of a target medium on which the printable format is to be printed. For example, the sensing engine(s) 108 correlates the position of the printed medium 204 with respect to scan area setting 316. The scan area setting 316 in turn may specify size of the target medium onto which the digitized file format of the printed medium 204 may be eventually printed.

At block 408, generating an outline preview of the printed medium with respect to an outline of the target medium based on the correlated position of the printed medium. For example, the rendering engine(s) 310 may generate an outline preview of the printed medium (i.e., the subject outline 210) with respect to the outline of the target medium (i.e., the target outline 208). Based on the relative position of the outlines, the user may determine whether any adjustments are to be carried out in the positioning of the printed medium 204.

FIG. 5 provides another example method for generating an outline preview of a printed medium. At block 502, a printed medium placed atop a supporting pane of a scanning system is detected. In one example, the sensing engine(s) 108 may monitor for signals generated by sensors 106. The sensors 106 in turn may generate an output signal on sensing presence of a printed medium 204 on the supporting pane 104. Based on the detection of the output signal, the sensing engine(s) 108 may determine that a printed medium 204 is positioned onto the supporting pane 104 of the system 102.

At block 504, signals from proximity sensors, generated in response to sensing a printed document, are obtained. In one example, the sensing engine(s) 108 may monitor output signals from sensors 106. The signals generated by each of the sensors 106 may vary depending on their physical distance from the printed medium 204. In one example, each of the signal may be characterized by various attributes. The attributes of the signal, such as voltage, may vary depending on the proximity. For example, voltage of the signal from sensors further away may be less than voltage of the signals from sensors (e.g., sensors 106-1, 2, 8) which are closer to the printed medium 204. The scan area setting 316 may subsequently store information pertaining to the attributes as sensor data 318.

At block 506, the sensor data, is obtained and analyzed to determine the position of the printed medium on the supporting pane of the scanning system. In one example, the sensing engine(s) 108 may further analyze and process the sensor data 318 to determine the location of the printed medium 204 on the supporting pane 104. In another example, the sensing engine(s) 108 may utilize a mapping which correlates the sensor data 318 with points on the supporting pane 104. Based such a mapping, the sensing engine(s) 108 may estimate the position, i.e., placement of the printed medium 204 on the supporting pane 104. Once determined, the sensing engine(s) 108 stores the position of the printed medium 204 as position data 320.

At block 508, an input pertaining to a scan area setting is received. The scan area setting may define an area on the supporting pane which would be scanned. The defined area may additionally also correspond to size of a target medium on which the printable format is to be eventually printed. In one example, a user may select a scan area setting 316 from a set of various settings or may provide manual input as a scan area setting 316. In one example, the scan area setting 316 may store settings based on standardized paper size formats such as A series (i.e., A4, A5, etc.) and B series (i.e., B1, B2, etc.).

At block 514, an area to be scanned may be defined based on the scan area setting. In one example, upon selecting the scan area setting 316, the sensing engine(s) 108 may define an area, such as the scan area 206, on the supporting pane 104. The area is so defined, such that the system 102 would scan such a defined area 206 present on the supporting pane 104. The scan area in turn would result in a digitized file format which would conform to the selected paper size based on the scan area setting 316.

At block 512, an outline preview of the printed medium with respect to an outline of the target medium is generated. The outline preview of the printed medium and the target medium is based on the correlated position of the printed medium. For example, the rendering engine(s) 310 may generate an outline preview of the printed medium (i.e., the subject outline 210) with respect to the outline of the target medium (i.e., the target outline 208). Based on the relative position of the outlines, the user may determine whether any adjustments are to be made while the positioning of the printed medium 204.

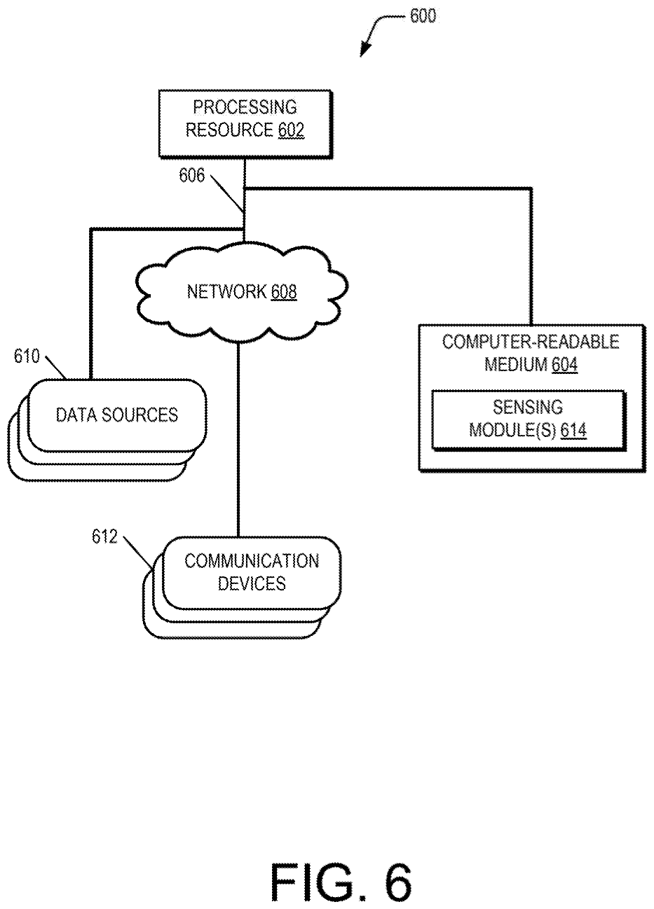

FIG. 6 illustrates a system environment 600 for generating an outline preview of a printed medium, according to an example of the present disclosure. The system environment 600 may comprise at least a portion of a public networking environment or a private networking environment, or a combination thereof. In one implementation, the system environment 600 includes a processing resource 602 communicatively coupled to a computer readable medium 604 through a communication link 606.

For example, the processing resource 602 can include either a single processor or a group of processors of a computing device for generating an outline preview of a printed medium. In another example, multiple processors may also be used for implementing the processing resource 602. The computer readable medium 604 may be, for example, an internal memory device of the computing device or an external memory device. In one implementation, the communication link 606 may be a direct communication link, such as any memory read/write interface. In another implementation, the communication link 606 may be an indirect communication link, such as a network interface. In such a case, the processing resource 602 can access the computer readable medium 604 through a network 608. The network 608 may be a single network or a combination of multiple networks and may use a variety of different communication protocols.

The processing resource 602 and the computer readable medium 604 may also be coupled to data sources 610 through the communication link 606, and/or to communication devices 612 over the network 608. The coupling with the data sources 610 enables in receiving the data in an offline environment, and the coupling with the communication devices 612 enables in receiving the data in an online environment.

In one implementation, the computer readable medium 604 includes a set of computer readable instructions, implementing a sensing module(s) 614. The instructions implementing usage sensing module(s) 614 may, in one example, be executable code for generating an outline preview of a printed medium. The set of computer readable instructions within medium 604 may be accessed by the processing resource 602 through the communication link 606 and subsequently executed to process data communicated with the data sources 610 in order for generating an outline preview of a printed medium.

For generating an outline preview of a printed medium, the sensing module(s) 614 may sense or ascertain positioning of a printed medium, such as the printed medium 204 on a supporting pane 104 of a scanning system such as system 102. The positioning of the printed medium 204 may further activate the sensors 106. The sensing module(s) 614 may ascertain that a printed medium, such as the medium 204 is positioned on the supporting pane 104 based on detecting signals obtained from the sensors 106.

The sensing module(s) 614 may thereafter continuously monitor signals being generated by the sensors 106. While monitoring, the sensing module(s) 614 may determine attributes corresponding to the signals from the sensors 106. Example of an attribute include but is not limited to measure of voltage of the signal. The attributes of signals may vary depending on the distance of the sensors 106 from the edges of the printed medium 204. The value of the attributes may be measured and stored in sensor data 318.

The sensing module(s) 614 may further enable processing of the sensor data 318 to determine the location of the printed medium 204 on the supporting pane 104. For example, the sensing module(s) 614 may utilize a mapping which correlates the sensor data 318 with points on the supporting pane 104. Based such a mapping, the sensing module(s) 614 may estimate the position, i.e., placement of the printed medium 204 on the supporting pane 104.

The sensing module(s) 614 may further obtain a scan area setting 316. The scan area setting 316 may be indicative of the size of the target medium onto which the digitized file format of the printed medium 204 may be eventually printed. Based on the scan area setting 316, the sensing module(s) 614 may define an area 206 on the supporting pane 104. The area is so defined, such that the system 102 would scan such a defined area 206. As explained previously the scan area 206 in turn would result in a digitized file format which would conform to the selected paper size, based on the scan area setting 316. While printing, a target medium conforming to the selected scan area setting 316 (e.g., paper size) would be selected onto which a physical representation of the digitized file format may be rendered or printed.

Continuing further, the sensing module(s) 614 may further enable rendering an outline 208 for the target medium based on the selected scan area setting 316. In one example, the sensing module(s) 614 may generate control instructions for generating the outline 208 of the target medium (referred to as the target outline 208). The control instruction when processed generate the target outline 208 on the display unit 202. In one example, the dimensions of the target outline 208 in turn are based on the scan area setting 316 selected by the user. In one example, the position of the target outline 206 may be with respect to the edges of the supporting pane 104.

Once the target outline 208 is generated, the sensing module(s) 614 may further generate control instructions which when processed render an outline 210 of the printed medium 204 (referred to as the subject outline 210) on the display unit 202. The control instructions are such that the sensing module(s) 614 may render the subject outline 210 relative to the target outline 208. As would be observed, the relative position of the target outline 208 with respect to the subject outline 210 is based on the relative position of the printed medium 204 on the supporting pane 104, with respect to scan area 206 defined by the scan area setting 316. The subject outline 210 and the target outline 208 when rendered onto the display unit 202, give an estimation of the position of the printed medium 204 on the supporting pane 104 to the user. In one example, the target outline 208 and the subject outline 210 may be represented in different visual indicators. The user may accordingly, adjust the position of the printed medium 204 on the supporting pane 104 till it is appropriately positioned. When the position of the printed medium 204 is appropriate, the user may proceed and initiate the scanning process for the printed medium 204.

Although examples for the present disclosure have been described in language specific to structural features and/or methods, it should stood that the appended claims are not necessarily limited to the specific features or methods described. Rather, the specific features and methods are disclosed and explained as examples of the present disclosure.

We claim:

1. A system for scanning a printed medium, the system comprising:
a horizontal supporting pane to accommodate the printed medium which is to be scanned;
a plurality of sensors arranged in an array beneath the supporting pane;
a sensing engine to:
detect position of the printed medium present on the supporting pane based on physical distance of the printed medium with each of the plurality of sensors;
correlate the position of the printed medium with respect to a specified scan area setting, the scan area setting being indicative of size of a target medium; and
generate preview of an outline of the printed medium with respect an outline of the target medium based on the correlated position of the printed medium.

2. The system as claimed in claim 1, wherein the array of the plurality of sensors is two dimensional and extends in a plane beneath the supporting pane.

3. The system as claimed in claim 1, wherein each of the plurality of sensors are to generate a voltage signal corresponding to the physical distance of the each of the plurality of sensors from an edge of the printed medium.

4. The system as claimed in claim 1, wherein the sensing engine is to further:
obtain voltage signals from each of the corresponding plurality of sensors; and
estimating position of an edge of the printed medium based on the obtained voltage signals.

5. The system as claimed in claim 4, wherein the sensing engine is to further generate an outline of the printed medium based on estimated positions of the edge and other edges of the print medium.

6. The system as claimed in claim 1, further comprising a display unit to:
receive the outline preview of the printed medium and the outline of the target medium; and
display the outline preview overlaying the outline of the target medium.

7. The system as claimed in claim 1, wherein each of the plurality of sensors is one of capacitive based proximity sensor and a photoelectric based proximity sensor.

8. The system as claimed in claim 1, wherein the digitized printed medium is rendered onto the target medium.

9. A method comprising:
ascertaining presence of a printed medium atop a supporting pane fitted onto an enclosed housing of a scanning system using a plurality of sensors arranged in an array beneath the supporting pane;
estimating position of the printed medium present on the supporting pane based on proximity of the printed medium with each of the plurality of sensors;
correlating the position of the printed medium in relation to a specified scan area setting, wherein the scan area setting is indicative of size of a target medium; and
generating an outline preview of the printed medium with respect to an outline of the target medium based on the correlated position of the printed medium.

10. The method as claimed in claim 9, wherein the estimating the position of the printed medium further comprises:
measuring a voltage signal generated by each of the plurality of sensors in response to sensing of an edge of the printed medium; and
determining the position of the printed medium based on measured voltage signal generated by each of the plurality of sensors.

11. The method as claimed in claim 9, wherein the specified scan area corresponds to standardized paper sizes for the target medium.

12. The method as claimed in claim 9, wherein the generating the outline preview comprises:
receiving the outline preview of the printed medium and the outline of the target medium; and
displaying the outline preview overlaying the outline of the target medium onto a display unit.

13. The method as claimed in claim 12, the method further comprising:
on displaying, determining whether the outline preview and the outline of the target medium intersect at a point; and
based on the determining, generating one of n audio or visual alert for a user.

14. A non-transitory computer-readable medium comprising instructions executable by a processing resource to:
ascertain presence of a printed medium atop a supporting pane of a scanning system, wherein the scanning system further comprises an array of sensors beneath the supporting pane;
estimate position of the printed medium present on the supporting pane based on proximity of the printed medium with the sensors;
correlate the position of the printed medium in relation to a specified scan area setting, the scan area setting being indicative of size of a target medium on which the printed medium is to be printed; and
generate control instruction for rendering an outline preview of the printed medium with respect to an outline of the target medium based on the correlated position of the printed medium.

15. The non-transitory computer-readable medium as claimed in claim 14, further comprising instruction to estimate position of an edge of the printed medium based on voltage signals obtained from each of the corresponding sensors.
